(19) United States
(12) Patent Application Publication
(10) Pub. No.: US 2002/0041400 A1
(43) Pub. Date: Apr. 11, 2002

(54) Method for transporting facsimile information in IP-based networks

(76) Inventor: Klaus Hunlich, Neuching (DE)

Correspondence Address: Kevin R. Spivak, Morrison & Foerster LLP, 2000 Pennsylvania Ave., N.W., Washington, DC, 20006-1888, US

(21) Appl. No.: 09/961,389

(22) Filed: Sep. 25, 2001

(30) Foreign Application Priority Data
Sep. 26, 2000 (DE) 10047651.1

(51) Int. Cl. H04N 1/00

(52) U.S. Cl. 358/407; 358/405

(57) ABSTRACT

The invention relates to a method of transmitting data, and in particular facsimile data, of at least one first subscriber to at least one second subscriber, with the subscribers having a real-time communication link, in which the at least one first subscriber establishes a real-time connection to at least one first intermediate station and transmits data to the station, the at least one first intermediate station forwards the data to at least one second intermediate station over a connection which at least in part does not support real-time transmission, and a real-time connection is established between the at least one second subscriber and at least one second intermediate station and the data is transmitted to the at least one second subscriber.

### CLAIM OF PRIORITY

This application claims priority to German Application No. 10047651.1 which was published in the German language on Sep. 26, 2000.

### TECHNICAL FIELD OF THE INVENTION

The invention relates to a method of transmitting data, and in particular, to transmitting facsimile data, of at least one first subscriber to at least one other subscriber, the subscribers having a real-time communication link.

### BACKGROUND OF THE INVENTION

In conventional data transmission methods, data is typically transmitted over a telephone connection established to another subscriber via a switching unit. The data is transmitted from one fax machine to another fax machine, and receipt of a successful transmission is acknowledged. Transmission of facsimiles using a conventional telephone connection established between two subscribers can be relatively costly, particularly when large distances are involved. Hence, the comparatively inexpensive Internet is increasingly being used for such connections.

One problem that arises from using the Internet is that certain subscribers, for example a fax machine, requires direct transmission in real time. This requirement for real-time transmission with error protection is not accounted for when using a TCP/IP-based network. This results in a large number of transmission errors occurring during fax transmissions over the Internet, which leads to an additional load on the network. Both factors are obstacles to real commercial exploitation.

### SUMMARY OF THE INVENTION

In one embodiment of the invention, there is a method of transmitting data from at least a first subscriber to at least a second subscriber. The method includes, for example, establishing a real-time connection to at least one first intermediate station and transmitting data to the first intermediate station, forwarding, from the at least one first intermediate station, the data to at least one second intermediate station over a connection which at least in parts does not support real-time transmission, and establishing real-time connection between the at least one second subscriber and the at least one second intermediate station, and transmitting the data to the at least one second subscriber.

In one aspect of the invention, the reception of the data of the at least one first subscriber by the at least one first intermediate station is acknowledged.

In another aspect of the invention, the reception of the data by the at least one second subscriber is acknowledged to the at least one second intermediate station.

In still another aspect of the invention, the reception of the data of the at least one first subscriber is acknowledged by the at least one second subscriber, and the acknowledgement is transmitted over the entire link to the at least one first subscriber.

In yet another aspect of the invention, the at least one first intermediate station forwards the data to the at least one second intermediate station over a network at least in part based on TCP/IP.

In still another aspect of the invention, the at least one first intermediate station and the at least one second intermediate station act in the form of a proxy.

In another embodiment of the invention, there is a intermediate station sending data from at least one first subscriber to at least one second subscriber, the subscribers having a real-time communication link. The invention includes, for example, at least one first intermediate station forwarding data to at least one second intermediate station over a connection which at least in part does not support real-time transmission, wherein a real-time connection is established between the at least one second subscriber and the at least one second intermediate station and the data is transmitted to the at least one further subscriber.

In one aspect of the invention, the intermediate station is configured as a proxy.

In another aspect of the invention, the communication link is a connection of a TCP/IP-based network.

In still another aspect of the invention, the communication link between the at least one first subscriber and at least one second subscriber is a real-time link.

### BRIEF DESCRIPTION OF THE DRAWINGS

The invention is explained in greater detail below with reference to the exemplary embodiments shown in the drawing, in which:

FIG. 1 shows a schematic representation of a distributed switching system and realization of a communication link according to the invention.

FIG. 2 shows a schematic representation of the temporal sequence of the data transmission between the individual stations.

### DETAILED DESCRIPTION OF THE PREFERRED EMBODIMENTS

The present invention provides a method of transmitting data, and in particular facsimile data, of at least one subscriber to at least another subscriber which meets the requirement for a real-time communication link. At least parts of the communication link, however, being realized in the form of a non-real-time connection. A further embodiment of the present invention provides an intermediate station for performing such a method.

As a result of the establishment of a real-time connection between the respective subscriber and the respective intermediate station, the respective subscriber is provided with a real-time connection partner. However, it is in the form of an intermediate station instead of another subscriber, so that existing terminals having such requirements (e.g., fax machines) can communicate directly and reliably with their respective intermediate station in real-time as required.

Moreover, the overall link between two subscribers can be split into one or more further link segments that need not support the requirements, around for example a network whose layers 1 and 2 are based on a transmission method that can approximately meet the real-time requirements (for example Ethernet).

A connection of this type also need not necessarily be bidirectional. For example, when the information to be transmitted is split into a plurality of data blocks in one direction, even error-protected transmission is possible by transmitting the correct or incorrect (reception) acknowledgement. That is, it may be determined by redundancy checking in the other direction between the blocks and/or at the end of the overall transmission, i.e. unidirectionally in each case.

In this case, following the successful and verified correct transmission of at least one first intermediate station, a terminal can receive the transmission result as an acknowledgement. This results in not receiving notification of the real transmission over the non-real-time link, nor of the transmission between at least one further intermediate station and the at least one further (additional) subscriber. It is nevertheless possible to achieve a high degree of reliability in the overall link or overall connection by means of error-protected transmission (with acknowledgement in each case) in the respective link segments.

If there is a requirement for a real acknowledgement from the end subscriber, the acknowledgement of the at least one additional subscriber can be sent back to the at least one subscriber over the entire communication link. This results in the latter being notified of a correct or incorrect (overall) transmission and initiates appropriate actions, such as the displaying of the correct or incorrect result with a repeated transmission attempt if appropriate.

An acknowledgement of this type can be performed in addition to the customary (first) acknowledgement between the subscriber and the intermediate station. However it is also conceivable to dispense with this acknowledgement by means of a slight modification to an end subscriber and to allow a possibly longer predetermined period for waiting for the final acknowledgement.

In a preferred embodiment of the invention, the method is used on a communication link which is realized at least in parts as a TCP/IP-based network, for example the Internet, intranet, etc. The local network accesses often used for this purpose can be designed as special proxies that support a conventional Internet connection between at least two proxies and represent a real-time connection in the direction of the end subscriber, so that for example said proxy acts as a fax proxy, i.e. the receiving fax machine, for a fax machine.

The method, as well as an intermediate station of this type, can be used for any subscribers having real-time requirements and where at least parts of the communication link are realized using inexpensive non-real-time connections.

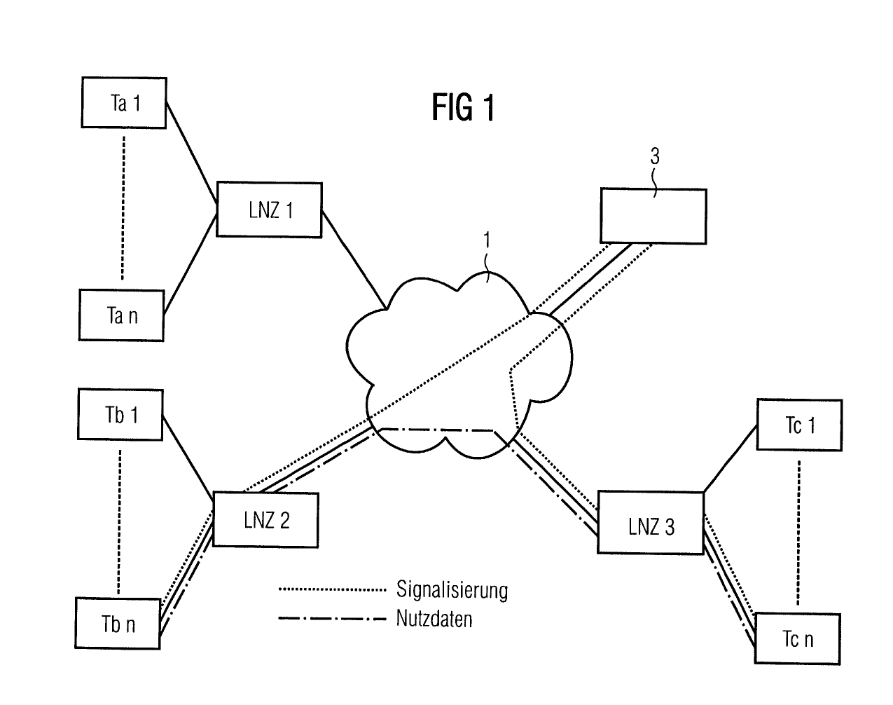

The distributed switching system illustrated in FIG. 1 has a TCP/IP-based network 1, such as the Internet for example, over which one or more subscribers Ta 1 to Ta n, Tb 1 to Tb n, Tc 1 to Tc n of any type can communicate with one another in pairs or in larger groups or conferences. For this purpose a plurality of subscribers, for example a group, an intranet, a local area network etc., are connected to the Internet 1 via a local network access LNZ 1 to LNZ 3, with a connection between a subscriber pair, such as indicated by a dot-dashed line in FIG. 1, Tb n to Tc n being established via the corresponding local network accesses LNZ 2 and LNZ 3 and the Internet by means of a switching unit or switching logic unit 3 responsible for this.

With this method, the connection is established by signaling (indicated by a dotted line in FIG. 1) by means of a switching unit 3, and the data is transmitted over the connection established in this manner. The local network accesses LNZ 1 to LNZ 3 illustrated in FIG. 1 are of course only examples, so that any number of subscribers can be connected via any number of local network accesses and can exchange data over the network 1 in this manner by means of the switching logic unit 3. The switching logic unit can also be physically part of an LNZ.

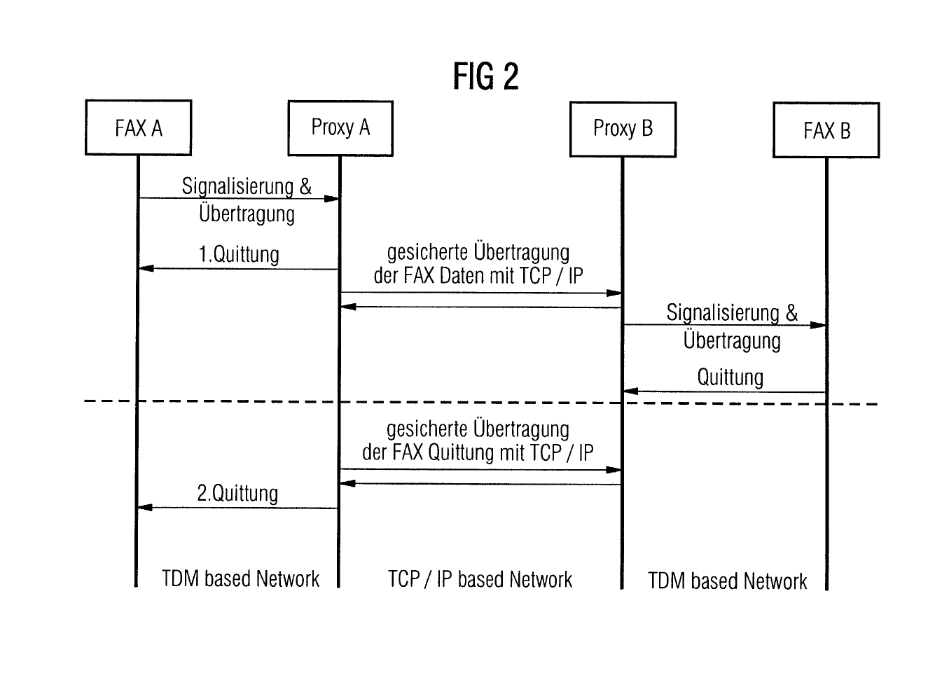

The data transmission and its temporal sequence as stipulated by the method according to the invention, and are illustrated in FIG. 2. Reference is made to the example of a facsimile transmission between the fax machine of a subscriber A (Fax A) and the fax machine of a subscriber B (Fax B). According to the invention, there is a direct transmission in real time between the fax machine of subscriber A (fax with data to be transmitted) Fax A and the suitably designed local network access in the form of a fax proxy Proxy A.

As with a typical fax transmission, readiness to transmit or readiness to receive a transmission can be signaled first, followed by the transmission of the fax information from the fax machine of subscriber A (Fax A) to the fax proxy (Proxy A). Following the transmission, the reception or transmission result is checked in fax proxy (Proxy A) on the basis of redundant information included in the transmitted information and is then transmitted back as a first acknowledgement from fax proxy (Proxy A) to the fax machine of subscriber A (Fax A).

This is followed by data transmission of the information to be transmitted present in the fax proxy (Proxy A), for example in a buffer, between the fax proxy (Proxy A) and the fax proxy (Proxy B), with a very simple network with inexpensive connections (for example a communications protocol based on layer 1 or 2) being adequate for this data transmission. A preferably error-protected transmission can also be performed by acknowledging (intermediate acknowledgement and/or final acknowledgement) the correct reception of the (partial) information or all the information in fax proxy (Proxy B), for example by checking redundant information included in the transmission and transmitting said acknowledgement back to fax proxy (Proxy A). Since this acknowledgement need not be transmitted at the same time as the information to be transmitted, even a unidirectional link is adequate for this purpose.

Following signaling of the fax machine of subscriber A (Fax A) and the respective connection establishment, the information received in fax proxy (Proxy B) is transmitted to the fax machine, and a conventional fax machine acknowledges this on correct reception. Since the fax machine of subscriber A (Fax A) has already received an acknowledgement in the form of a first acknowledgement from the fax proxy (Proxy A), this acknowledgement according to the first exemplary embodiment is however not obligatory, since the fax machine of subscriber A does not receive or is not forwarded the acknowledgement of fax subscriber B.

According to the first exemplary embodiment (half above the dashed line in FIG. 2), a connection is established between a fax machine of subscriber A (Fax A) and the fax machine of a subscriber B (Fax B) with a corresponding fax proxy (Proxy A), (Proxy B), with the respective fax proxy (Proxy A), (Proxy B) being interpreted as the remote fax machine or remote station by the respective fax machine Fax A, Fax B. In this case the terminals of subscribers Fax A, Fax B are unaware of the further communication link between the fax proxy (Proxy A) and the fax proxy (Proxy B) or even a multiplicity of proxies.

Despite the fact that according to this first exemplary embodiment of the invention no final acknowledgement of the reception of the information is transmitted back by the other terminal Fax B to the transmitting terminal Fax A, it is possible to ensure a high degree of reliability in this manner, as both the transmission path between the proxies, that is to say on the Internet 1, and the link between the other fax proxy (Proxy B) and the receiving fax machine of subscriber B (Fax B) are highly reliable if protocols such as FCP, for example, are used. Any splitting into blocks and repeated transmission of erroneous blocks, such as on the Internet 1 by means of TCP/IP for example, and a concomitant longer transmission time are negligible disadvantages given the low connection costs.

For specific applications which require a definitive confirmation of the reception of the information at the remote station Fax B, for example for legal, commercial, security or other reasons, according to a second exemplary embodiment (FIG. 2, below the dashed line) an acknowledgement of this type can be transmitted back. In this case, after the transmitted fax information is received, this is acknowledged by the fax machine of subscriber B (Fax B) and the acknowledgement is transmitted back to fax proxy (Proxy B).

The acknowledgement received in fax proxy (Proxy B) is transmitted, in the opposite direction to the information previously transmitted, by fax proxy (Proxy B) to fax proxy (Proxy A) with any further intermediate stations (further fax proxies). This transmission can also be error-protected by confirming its reception. As illustrated, the acknowledgement received in fax proxy (Proxy A) can be transmitted as a second acknowledgement in the real-time communication link to the fax machine of subscriber A (Fax A). Following an appropriate modification to the fax machine of subscriber A (Fax A), it is also conceivable that the latter does not expect a first acknowledgement within a given time, so that said first acknowledgement can be dispensed with.

According to the transmission method of the invention, it is advantageous to allow fax machines to receive and transmit using different fax protocols since there is no direct connection between the fax machines with the method according to the invention. Accordingly it is possible, for example, for the fax machine of subscriber A (Fax A) to use a Group 3 fax protocol while the fax machine of subscriber B (Fax B) uses a Group 2 protocol. The prerequisite for this is that a proxy supports at least the protocols used by a fax machine connected via the real-time communication link. Advantageously, each fax proxy (Proxy A), (Proxy B) should support all fax protocols to enable the connection of any type of fax machine.

Although the method according to the invention was described with reference to a communication link between two fax machines (Fax A), (Fax B), this method can of course be applied to any terminals which require data transmission in real time, or which transmit data to another terminal and expect acknowledgement of the reception of said data within a given time.

The Internet in particular is currently a very inexpensive network that as a rule does not support these requirements, or only with difficulty and with a great deal of technical effort. Also possible are other networks, power grids for data transmission etc. which, in comparison with existing networks with real-time requirements, are relatively inexpensive owing to the lack of such requirements.

What is claimed is:

1. A method of transmitting data from at least one first subscriber to at least one second subscriber, comprising:
establishing a real-time connection to at least one first intermediate station and transmitting data to the first intermediate station;
forwarding, from the at least one first intermediate station, the data to at least one second intermediate station over a connection which at least in part does not support real-time transmission; and
establishing real-time connection between the at least one second subscriber and the at least one second intermediate station, and transmitting the data to the at least one second subscriber.

2. The method as claimed in claim 1, wherein reception of the data of the at least one first subscriber by the at least one first intermediate station is acknowledged.

3. The method as claimed in claim 1, wherein the reception of the data by the at least one second subscriber is acknowledged to the at least one second intermediate station.

4. The method as claimed in claim 1, wherein the reception of the data of the at least one first subscriber is acknowledged by the at least one second subscriber, and the acknowledgement is transmitted over the entire link to the at least one first subscriber.

5. The method as claimed in claim 1, wherein the at least one first intermediate station forwards the data to the at least one second intermediate station over a network at least in part based on TCP/IP.

6. The method as claimed in claim 1, wherein the at least one first intermediate station and the at least one second intermediate station act in the form of a proxy.

7. An intermediate station sending data from at least one first subscriber to at least one second subscriber, the subscribers having a real-time communication link, comprising:
at least one first intermediate station forwarding data to at least one second intermediate station over a connection which at least in part does not support real-time transmission, wherein
a real-time connection is established between the at least one second subscriber and the at least one second intermediate station and the data is transmitted to the at least one further subscriber.

8. The intermediate station as claimed in claim 7, wherein the intermediate station is configured as a proxy.

9. The intermediate station as claimed in claim 7, wherein the communication link is a connection of a TCP/IP-based network.

10. The method as claimed in claim 1, wherein the communication link between the at least one first subscriber and at least one second subscriber is a real-time link.
